(19) United States
(12) Patent Application Publication
(10) Pub. No.: US 2011/0290791 A1
(43) Pub. Date: Dec. 1, 2011

(54) HIGH-FREQUENCY HEATING DEVICE

(75) Inventors: Takahide Yamaguchi, Nara (JP); Shinichi Sakai, Nara (JP); Masaharu Tsujimoto, Nara (JP); Junji Hirata, Shiga (JP)

(73) Assignee: PANASONIC CORPORATION, Kadoma-shi, Osaka (JP)

(21) Appl. No.: 13/148,229

(22) PCT Filed: Feb. 2, 2010
(86) PCT No.: PCT/JP2010/000618

§ 371 Date: Aug. 5, 2011

(30) Foreign Application Priority Data
Feb. 6, 2009 (JP) 2009-026003

(51) Int. Cl. H05B 6/64

(52) U.S. Cl. 219/756

(57) ABSTRACT

To provide a high-frequency heating device of which reduction of weight and cost can be achieved, while a leakage of high-frequency waves is prevented. A high-frequency heating device 10 includes a switch unit 17 which is provided between a heating chamber and a machine chamber inside a casing 11, at a corner of an opening of the heating chamber remote from a hinge, and pressed with pins 18, 19 which are provided on a door 14, when the door 14 closes the opening, a door arm which is provided in the casing 11 at a diagonal position of the opening with respect to a position of arranging the switch unit 17, and bridged between the casing 11 and the door 14 thereby to draw the door 14 to the casing 11, when the opening of the heating chamber is closed with the door 14, a protruding portion 42 provided on the pin 19 and protruding in a direction intersecting a longitudinal direction of the pin 19, and a rack unit 23 which is arranged between a wall member 21 of the casing 11 and the switch unit 17, urged toward an opposite side to the protruding direction of the protruding portion 42, and adapted to move in the protruding direction of the protruding portion 42, when the rack unit is pressed with the protruding portion 42.

### TECHNICAL FIELD

The present invention relates to a high-frequency heating device including a heating chamber and a machine chamber provided in a casing, and provided with a door which is connected to the casing by means of a hinge and which can open and close an opening of the heating chamber.

### BACKGROUND ART

There has been a high-frequency heating device including a heating chamber and a machine chamber provided in a casing, in which a door is connected to a lower portion of an opening of the heating chamber by means of a hinge, and a pair of door arms arranged at both sides of the heating chamber are connected to both the casing and the door (see Patent Document 1, for example).

In the high-frequency heating device, the door is provided with one pin for actuating a first interlock and the other pin for actuating a second interlock, at a machine chamber side. When the door closes the opening, the two pins press a switch unit so that the door is brought into tight contact with the casing by means of a pair of the door arms.

Related Art Documents

Patent Documents

Patent Document 1: JP-A-11-214147 (FIG. 2 and paragraphs 0019 and 0022)

### SUMMARY OF THE INVENTION

Problem to be Solved by the Invention

However, in Patent Document 1, the two pins are used only for actuating the two interlocks. Therefore, a drawing force for bringing the door into tight contact with the casing depends on a pair of the door arms.

Meanwhile, the door arms are connected to the door through door arm holes which are formed in a wall member of the casing, and for this reason, a leakage of high-frequency waves through the door arm holes is concerned.

On the other hand, it has been recently considered to provide the door arm only at one side, for the purpose of reducing weight and cost.

In case of providing the door arm only at one side, the door arm at the machine chamber side out of the two door arms is positioned close to a base board of the switch unit, and hence, there is such anxiety that the high-frequency waves may leak through the door arm hole.

In contrast, the door arm remote from the machine chamber is positioned remote from the base board of the switch unit, and hence, there is less anxiety of the leakage of the high-frequency waves through the door arm hole.

Under the circumstances, it is necessary to provide the door arm only at one side, considering the leakage of the high-frequency waves through the door arm hole.

The invention has been made in order to solve the above described problem, and an object of the invention is to provide a high-frequency heating device of which reduction of weight and cost can be achieved, while a leakage of high-frequency waves is prevented.

Means for Solving the Problem

A high-frequency heating device according to the invention includes: a casing including a heating chamber and a machine chamber; a door which is connected to the casing by means of a hinge and can open or close an opening of the heating chamber; a switch unit which is provided between the heating chamber and the machine chamber inside the casing and at a corner of the opening remote from the hinge, and which is pressed by a pin provided on the door when the door closes the opening; a door arm which is provided in the casing at a diagonal position of the opening with respect to a position of the switch unit, and which is bridged between the casing and the door thereby to draw the door to the casing when the opening of the heating chamber is closed with the door; a protruding portion provided on the pin and protruding in a direction intersecting a longitudinal direction of the pin; and a rack unit which is arranged between a wall member of the casing and the switch unit, which is urged toward an opposite side to the protruding direction of the protruding portion, and which moves in the protruding direction of the protruding portion when the rack unit is pressed by the protruding portion.

In the invention, the rack unit which is urged toward the opposite side to the protruding direction of the protruding portion of the pin is moved in the protruding direction of the protruding portion, and then moved back thereby to restrain the pin.

In this manner, the opening of the heating chamber can be reliably closed with the door, even though the single door arm is provided at the diagonal position of the opening with respect to the position of arranging the switch unit.

As the results, it is possible to reduce weight and cost, while a leakage of the high-frequency waves is prevented.

In the high-frequency heating device according to the invention, a spring is suspended between the switch unit and the rack unit.

In this invention, the rack unit is urged by the spring.

Accordingly, it is possible to urge the rack unit in the direction opposite to the protruding direction of the protruding portion with a simple structure and at a low cost, and at the same time, it is possible to move the rack unit in the protruding direction of the protruding portion, when the rack unit is pressed with the protruding portion.

Advantages of the Invention

The high-frequency heating device according to the invention includes: the switch unit which is provided between the heating chamber and the machine chamber inside the casing and at the corner of the opening remote from the hinge, and which is pressed by the pin provided on the door when the door closes the opening; the door arm which is provided in the casing at the diagonal position of the opening with respect to the position of the switch unit, and which is bridged between the casing and the door thereby to draw the door to the casing when the opening of the heating chamber is closed with the door; the protruding portion provided on the pin and protruding in the direction intersecting the longitudinal direction of the pin; and the rack unit which is arranged between the wall member of the casing and the switch unit, which is urged toward an opposite side to the protruding direction of the protruding portion, and which moves in the protruding direction of the protruding portion when the rack unit is pressed by the protruding portion.

This configuration provides advantages of reducing weight and cost, while a leakage of the high-frequency waves is prevented.

### BRIEF DESCRIPTION OF THE DRAWINGS

FIG. 1 is a perspective view of an outlook of a high-frequency heating device in an embodiment according to the invention, as seen diagonally from a front side.

FIG. 2 is a vertical sectional view showing a region surrounding a switch unit in the high-frequency heating device as shown in FIG. 1.

FIG. 3 is a sectional view of the high-frequency heating device as shown in FIG. 2, taken along a line A-A.

FIG. 4 is a vertical sectional view of the high-frequency heating device as shown in FIG. 1, showing a region surrounding a rack unit when a door is opened.

FIG. 5 is a vertical sectional view of the high-frequency heating device as shown in FIG. 1, showing the region surrounding the rack unit when the door is closed.

### MODE FOR CARRYING OUT THE INVENTION

Now, a high-frequency heating device in an embodiment according to the invention will be described referring to the drawings.

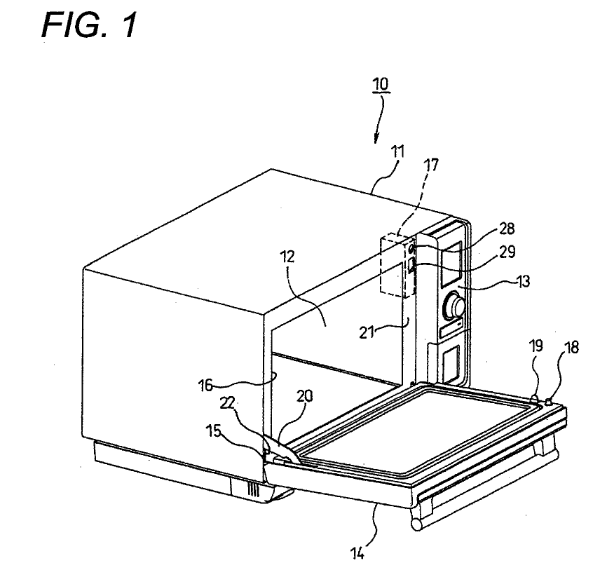

As shown in FIG. 1, a high-frequency heating device 10 in an embodiment according to the invention includes mainly a casing 11 having a heating chamber 12 and a machine chamber 13, a door 14 of a vertical opening type which is connected to the casing 11 by means of a hinge 15 and can open or close an opening 16 of the heating chamber 12, a switch unit 17 which is provided between the heating chamber 12 and the machine chamber 13 inside the casing 11, at a corner of the opening 16 remote from the hinge 15, and adapted to be pressed with pins 18, 19 which are provided on the door 14, when the opening 16 of the heating chamber 12 is closed with the door 14, and a single door arm 20 which is provided in the casing 11 at a diagonal position of the opening 16 with respect to a position of arranging the switch unit 17, and bridged between the casing 11 and the door 14 thereby to draw the door 14 to the casing 11, when the opening 16 of the heating chamber 12 is closed with the door 14.

The single door arm 20 is provided in the casing 11 at the diagonal position of the opening 16 with respect to the position of arranging the switch unit 17, that is, at a left end side of the heating chamber 12 in FIG. 1. Therefore, the door arm 20 is positioned remote from the switch unit 17, and less influenced by a leakage of high-frequency waves through a door arm hole 22 which is formed in a wall member 21 of the casing 11, at a left side in FIG. 1. There is no door arm hole at a right end side of the heating chamber 12 in FIG. 1.

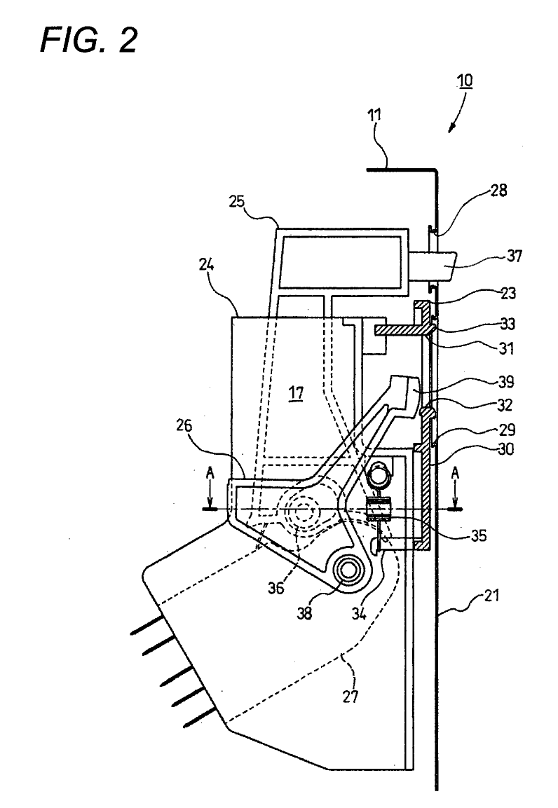

As shown in FIG. 2, the high-frequency heating device 10 is provided with a rack unit 23 which is arranged between the wall member 21 and the switch unit 17.

The switch unit 17 includes a base board 24, a first lever 25, a second lever 26, and a switch circuit portion 27 incorporating a plurality of micro switches which are not shown. The switch circuit portion 27 is electrically connected to a control circuit which is not shown. The switch circuit portion 27 is so designed as to permit operation of a driving circuit for a high-frequency wave generating device, which is not shown, depending on the logic that all of a plurality of the micro switches are turned on.

The wall member 21 is arranged on a front face of the casing 11, and has a first lever insertion hole 28 at its upper side and a second lever insertion hole 29 at its lower side.

The rack unit 23 includes a body plate portion 30 which is arranged in parallel with the wall member 21, and a second lever engaging hole 31 which is formed near an upper end of the body plate portion 30. The second lever engaging hole 31 has a second lever engaging protuberance 32 at its lower end, and a protrusion 33 in an annular shape which protrudes toward the wall member 21.

The rack unit 23 has a spring lock portion 34 which is formed at a lower end of the body plate portion 30. An urging spring 35 which is engaged with the casing 11 at its one end is engaged with the spring lock portion 34 at the other end. Therefore, the rack unit 23 is urged upward in FIG. 2, with a stroke until the protrusion 33 of the second lever engaging hole 31 comes into contact with the second lever insertion hole 29 of the wall member 21.

As the results, the rack unit 23 is reliably urged upward in FIG. 2, by the urging spring 35.

The first lever 25 is rotatably held by means of a first pivotal support shaft 36 which is formed on the base board 24, and urged in a clockwise direction in FIG. 2, by means of a return spring which is not shown. A first lever protruding portion 37 which is formed at a distal end of the first lever 25 protrudes toward the door 14 through the first lever insertion hole 28 of the wall member 21.

When the opening 16 of the heating chamber 12 is closed with the door 14, one of the pins 18 of the door 14 strikes the first lever protruding portion 37, and hence, the first lever 25 is rotated in a counterclockwise direction in FIG. 2, resisting the return spring. Then, one of the micro switches in the switch circuit portion 27 is turned on.

The second lever 26 is rotatably held by means of a second pivotal support shaft 38 which is formed on the base board 24 independently from the first pivotal support shaft 36, and urged in a clockwise direction in FIG. 2, by means of a return spring which is not shown. The second lever 26 is provided with a second lever protruding portion 39 at its distal end in such a manner that the second lever protruding portion 39 is positioned more backward of the casing 11 than the second lever insertion hole 29 of the wall member 21 and the second lever engaging hole 31 of the rack unit 23, that is, at a left side in FIG. 2.

When the opening 16 of the heating chamber 12 is closed with the door 14, the other pin 19 of the door 14 strikes the second lever protruding portion 39, and hence, the second lever 26 is rotated in the counterclockwise direction in FIG. 2, resisting the return spring. Then, one of the other micro switches in the switch circuit portion 27 is turned on.

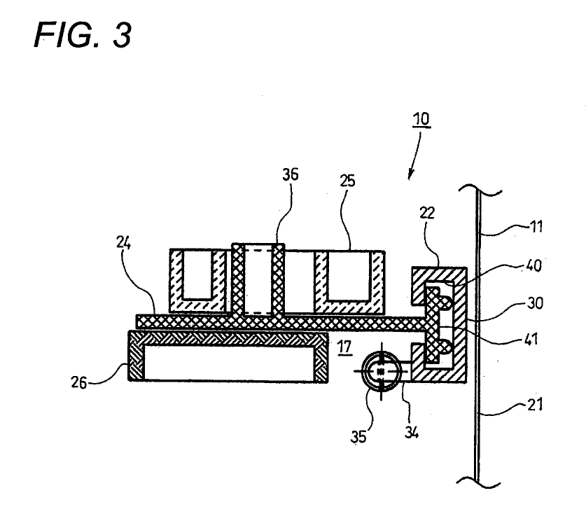

As shown in FIG. 3, the rack unit 23 has a guide 40 having a substantially C-shape in a horizontal sectional view, in a part of the body plate portion 30. The guide 40 is mounted on a rack support portion 41 of the base board 24 which has a substantially T-shape in a horizontal sectional view. Accordingly, the rack unit 23 is assembled to the base board 24 of the switch unit 17 so as not to drop, and held so as to move in a vertical direction in FIG. 2.

Then, a detailed structure and operation of the high-frequency heating device 10 will be described.

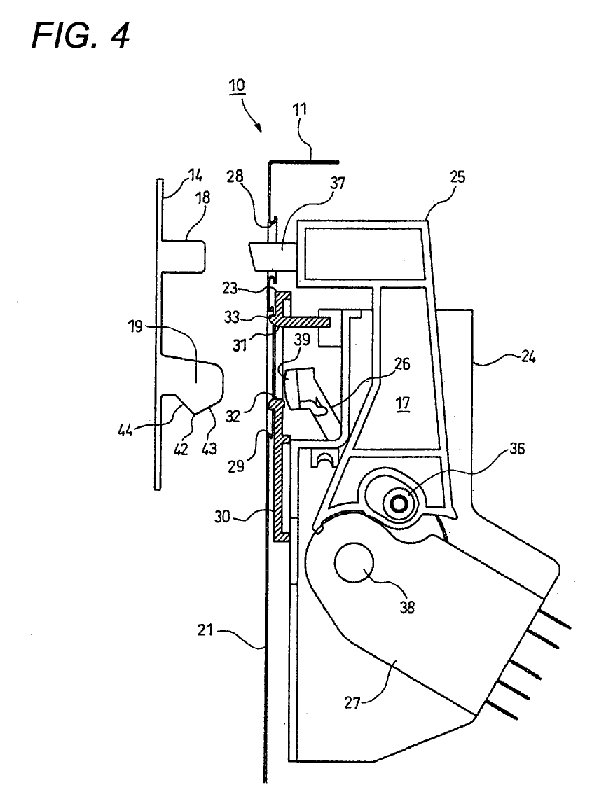

As shown in FIG. 4, the pin 19 of the door 14 has a protruding portion 42 which protrudes in a downward direction in FIG. 4 intersecting a longitudinal direction of the pin 19. A front inclined face 43 and a rear inclined face 44 are formed on the protruding portion 42.

When the opening 16 is closed with the door 14, the pins 18 and 19 advance respectively toward the first lever insertion hole 28 and the second lever insertion hole 29 of the wall member 21, following the closing motion of the door 14.

On this occasion, the first lever 25 is not yet pressed with the pin 18, and hence, one of the micro switches in the switch circuit portion 27 is kept off. The second lever 26 too is not yet pressed with the pin 19 in the same manner as the first lever 25, and hence, one of the other micro switches in the switch circuit portion 27 is kept off. Because the protrusion 33 of the second lever engaging hole 31 is butted against the second lever insertion hole 29 of the wall member 21, the rack unit 23 is held at a stroke end.

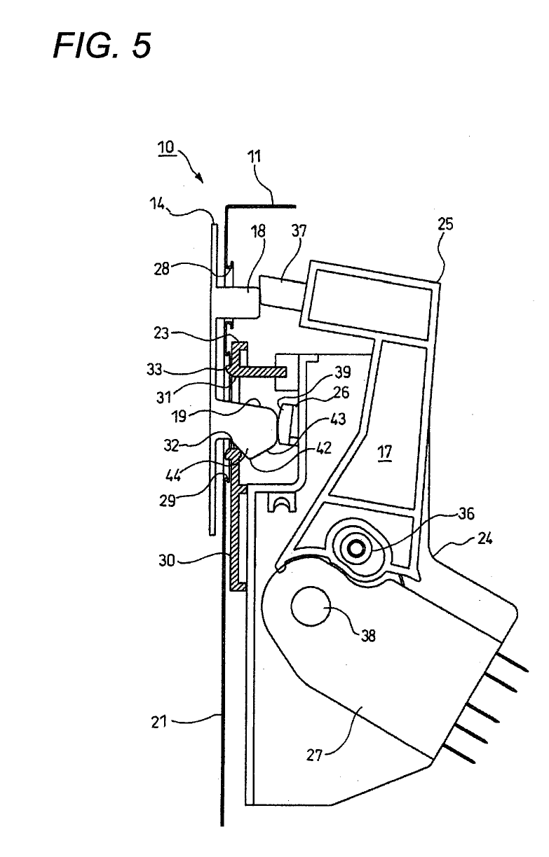

As shown in FIG. 5, as the closing motion of the door 14 proceeds, the pin 18 strikes the first lever protruding portion 37 of the first lever 25 through the first lever insertion hole 28 of the wall member 21. Accordingly, the first lever 25 is rotated in the clockwise direction in FIG. 5, resisting the return spring. Then, one of the micro switches in the switch circuit portion 27 is turned on, following the rotation of the first lever 25.

At the same time, the pin 19 passes the second lever insertion hole 29 of the wall member 21, and advances toward the second lever engaging hole 31 of the rack unit 23. Accordingly, the front inclined face 43 of the protruding portion 42 of the pin 19 overrides the second lever engaging protuberance 32 of the second lever engaging hole 31.

Because the front inclined face 43 of the protruding portion 42 of the pin 19 overrides the second lever engaging protuberance 32 of the second lever engaging hole 31, the rack unit 23 is moved downward in FIG. 5, resisting the urging spring 35. Thereafter, the rear inclined face 44 of the protruding portion 42 of the pin 19 is engaged with the second lever engaging. protuberance 32, and the rack unit 23 is moved back in the upward direction in FIG. 5, and then, stops.

On this occasion, the pin 19 strikes the second lever protruding portion 39 of the second lever 26. Accordingly, the second lever 26 is rotated in the clockwise direction in FIG. 5. Then, one of the other micro switches in the switch circuit portion 27 is turned on, following the rotation of the second lever 26. As the results, operation of the driving circuit for the high-frequency wave generating device is permitted.

Accordingly, the door 14 is drawn toward the casing 11 by the single door arm 20 which is arranged in the casing 11 at the diagonal position of the opening 16 with respect to the position of arranging the switch unit 17. At the same time, the rear inclined face 43 of the protruding portion 41 of the pin 19 is engaged with the second lever engaging protuberance 32, and thus, the opening 16 is reliably closed with the door 14.

In a closed state of the door 14 as shown in FIG. 5, when the door 14 is pulled from the casing 11 for opening it, the rear inclined face 44 of the protruding portion 42 of the pin 19 overrides the second lever engaging protuberance 32 of the second lever engaging hole 31, and on this occasion, the rack unit 23 moves downward in FIG. 5, resisting the urging spring 35.

Then, the rack unit 23 moves upward in FIG. 5 with an elastic repulsive force which is charged in the urging spring 35, and then, stops. As the pin 18 moves apart from the first lever 25, the pin 19 moves apart from the second lever 26, and the micro switches in the switch circuit portion 27 are respectively turned off. As the results, operation of the driving circuit for the high-frequency wave generating device is restrained.

In this embodiment, when the door 14 is closed, the rack unit 23 which has been urged in the direction opposite to the protruding direction of the protruding portion 42 of the pin 19 is moved in the protruding direction of the protruding portion 42, and then, moved back thereby to restrain the pin 19.

In this manner, the opening 16 of the heating chamber 12 can be reliably closed with the door 14, even though the single door arm 20 is provided at the diagonal position of the opening 16 with respect to the position of arranging the switch unit 17.

Therefore, it is possible to achieve reduction of the weight and cost, while the leakage of the high-frequency waves is prevented.

In this embodiment, the rack unit 23 is urged by the urging spring 35.

As the results, it is possible to urge the rack unit 23 in the direction opposite to the protruding direction of the protruding portion 42 with a simple structure and at a low cost. At the same time, it is possible to move the rack unit 23 in the protruding direction of the protruding portion 42, when the rack unit 23 is pressed with the protruding portion 42.

It is needless to say that the door 14 which is used in the above described embodiment may be applied as a lateral opening type instead of the vertical opening type.

Moreover, the casing 11, heating chamber 12, machine chamber 13, door 14, and so on which are used in the above described embodiment are not limited to those described by way of examples, but may be appropriately modified.

The invention is based on Japanese Patent Application filed on Feb. 6, 2009 (Application No. 2009-026003) of which contents are hereby incorporated by reference.

### Description of Reference Signs

10 High-frequency Heating Device

11 Casing

12 Heating Chamber

13 Machine Chamber

14 Door

15 Hinge

16 Opening

17 Switch Unit

18 Pin

19 Pin

20 Door Arm

23 Rack Unit

35 Urging Spring (Spring)

42 Protruding Portion

1. A high-frequency heating device comprising:
a casing comprising a heating chamber and a machine chamber;
a door which is connected to the casing by means of a hinge and can open or close an opening of the heating chamber;
a switch unit which is provided between the heating chamber and the machine chamber inside the casing and at a corner of the opening remote from the hinge, and which is pressed by a pin provided on the door when the door closes the opening;
a door arm which is provided in the casing at a diagonal position of the opening with respect to a position of the switch unit, and which is bridged between the casing and the door thereby to draw the door to the casing when the opening of the heating chamber is closed with the door;
a protruding portion provided on the pin and protruding in a direction intersecting a longitudinal direction of the pin; and
a rack unit which is arranged between a wall member of the casing and the switch unit, which is urged toward an opposite side to the protruding direction of the protruding portion, and which moves in the protruding direction of the protruding portion when the rack unit is pressed by the protruding portion.

2. The high-frequency heating device according to claim 1, wherein a spring is suspended between the switch unit and the rack unit.
